(19) United States
(12) Patent Application Publication
(10) Pub. No.: US 2006/0079593 A1
(43) Pub. Date: Apr. 13, 2006

(54) Hexaarylbiimidazole compounds and photopolymerization initiator compositions containing the same

(76) Inventors: Hirotoshi Kamata, Kanagawa (JP); Tatsuhiro Mizo, Kanagawa (JP); Mina Onishi, Kanagawa (JP)

Correspondence Address: SUGHRUE MION, PLLC, 2100 PENNSYLVANIA AVENUE, N.W., SUITE 800, WASHINGTON, DC, 20037, US

(21) Appl. No.: 10/531,665

(22) PCT Filed: Oct. 1, 2003
(86) PCT No.: PCT/JP03/12618

§ 371 Date: Apr. 15, 2005

Related U.S. Application Data
(60) Provisional application No. 60/419,093, filed on Oct. 18, 2002.

(30) Foreign Application Priority Data
Oct. 15, 2002 (JP) 2002-300446

(51) Int. Cl. C08F 2/50

(52) U.S. Cl. 522/39

(57) ABSTRACT

The present invention provides a novel hexaarylbiimidazole compound of the following formula (1): 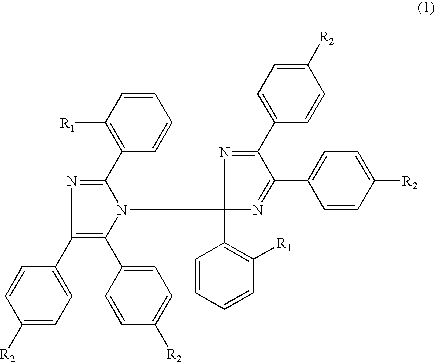
wherein each R₁ represents a halogen, and each R₂ represents an optionally substituted C₁₋₄ alkyl group. The hexaarylbiimidazole compound of the present invention is useful as photoradical generators in photopolymerizable compositions used as resists and is characterized by low sublimating thermal decomposition products. The photopolymerizable compositions may be suitably used as resists or as color filters for color liquid crystal display elements, cameras and the like.

### CROSS-REFERENCE TO RELATED APPLICATIONS

This application is an application filed under 35 U.S.C. § 111(a) claiming, pursuant to 35 U.S.C. § 119(e), of the filing date of Provisional Application 60/419,093 on Oct. 18, 2002, pursuant to 35 U.S.C. § 111(b).

### FIELD OF THE INVENTION

The present invention relates to novel hexaarylbiimidazole compounds. More particularly, it relates to hexaarylbiimidazole compounds which are useful as photoradical generators in photopolymerizable compositions used as resists and which are characterized by low sublimating thermal decomposition products, to photopolymerization initiator compositions containing the photoradical generators and to photopolymerizable compositions employing them. The photopolymerizable compositions of the invention may be suitably used as resists or as color filters for color liquid crystal display elements, cameras and the like.

### BACKGROUND OF THE INVENTION

Photopolymerizable compositions (photosensitive compositions) are widely used in several fields including the field of resists (photoresists, solder resists, etching resists, etc.).

In recent years, especially, demand has increased for photopolymerizable compositions that can be used as color filter resists satisfying requirements for excellent performance including high sensitivity, prolonged stability, high resolution and high heat resistance and light fastness in color filters used in color liquid crystal displays, color video cameras and the like.

A color filter is usually manufactured by forming a black matrix on the surface of a transparent substrate such as glass, and then forming a striped or mosaic pattern of three or more color phases such as red, green and blue to a precision of a few microns.

One of the typical manufacturing methods for a color filter is the pigment dispersion method which employs a coloring composition prepared by dispersing a pigment in a photosensitive composition. The pigment dispersion method is widely employed because of its high precision of color filter picture element position and film thickness, excellent durability including light fastness and heat resistance, and low generation of defects such as pinholes.

The pigment dispersion method forms various colored layers in a prescribed pattern form by coating a pigment-containing photosensitive composition on a substrate and subjecting it to photolithography. Specifically, the photosensitive composition for one filter color is coated onto a transparent substrate such as glass and subjected to patterning exposure, and the unexposed portions are removed by development with a solvent or alkali aqueous solution to form a first color pattern. This procedure is then repeated for all of the filter colors in order to complete manufacture of the color filter. The photosensitive composition is usually a negative type in consideration of the properties as a color filter and abundance of materials, and developing is carried out using virtually no organic solvents to avoid environmental problems, i.e. most development is alkali development employing alkali aqueous solutions.

In these manufacturing steps, it is common to accomplish baking after the developing step (post-baking). That is, after developing treatment, the transparent substrate having a pattern-formed cured photosensitive layer (also known as colored layer, picture element layer or resist layer) is heated (baked) at, for example, about 160-250° C. for about 10-120 minutes. Post-baking confers chemical and physical durability to the colored layer.

However, conventional photosensitive compositions used in resists often generate sublimates during post-baking after developing. These sublimates adhere to exhaust ducts and the like and, once adhered, can cause troubles by falling onto the resist layer. This has led to a desire for development of photosensitive compositions resistant to generation of sublimates even during baking steps, and especially for development of photosensitive compositions employing highly-sensitive, low-sublimating photopolymerization initiators.

The use of hexaarylbiimidazole-based compounds as components of photopolymerization initiator compositions for photosensitive compositions is known (see Patent Document 1, below), and for example, photosensitive compositions for color filters employing 2,2′-bis(2-chlorophenyl)-4,4′-5,5′-tetraphenyl-1,2′-biimidazole (HABI), represented by formula (4) below, as a component in the photopolymerization initiator compositions are disclosed in Japanese Unexamined Patent Publication HEI No. 6-75372 (see Patent Document 2, below) and Japanese Unexamined Patent Publication No. 2000-249822 (see Patent Document 3, below). Still, the problem of sublimates during post-baking is not dealt with in these documents, and.naturally therefore, they do not suggest the hexaarylbiimidazole compounds having the substituents of the invention which can solve the problem.

[Patent Document 1]

Japanese Examined Patent Publication SHO No. 45-37277

[Patent Document 2]

Japanese Unexamined Patent Publication HEI No. 06-075373

[Patent Document 3]

Japanese Unexamined Patent Publication No. 2000-249822

### SUMMARY OF THE INVENTION

It is an object of the present invention to provide photoradical generators with high sensitivity and low sublimation, photopolymerization initiator compositions employing them, and photopolymerizable compositions which generate few sublimates even during baking steps, and which are especially suitable for color filters.

As a result of diligent research on the problem described above, the present inventors discovered that the sublimates adhering to exhaust ducts during post-baking are crystals of the thermal decomposition products of hexaarylbiimidazole-based compounds used as photopolymerization initiators contained in the photopolymerization initiator compositions of photosensitive compositions, and have completed the present invention upon finding that the aforementioned problem can be overcome by photopolymerization initiator compositions employing as the photoradical generators novel hexaarylbiimidazole compounds having a specific structure, and by photopolymerizable compositions comprising them.

In other words, the invention provides hexaarylbiimidazole compounds according to the following [1] to [1], photoradical generators comprising them, photopolymerization initiator compositions employing the same, and photopolymerizable compositions containing them.

[1] A hexaarylbiimidazole compound as defined by the following formula (1): 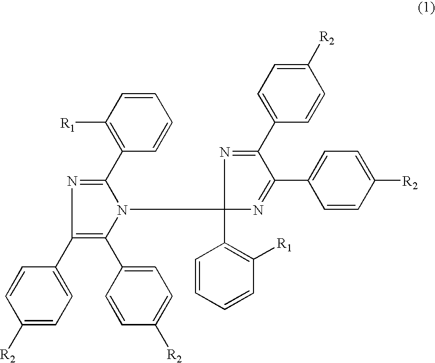
wherein each R₁ represents a halogen atom, and each R₂ represents an optionally substituted C₁₋₄ alkyl group.

A hexaarylbiimidazole compound as defined by the following formula (2):

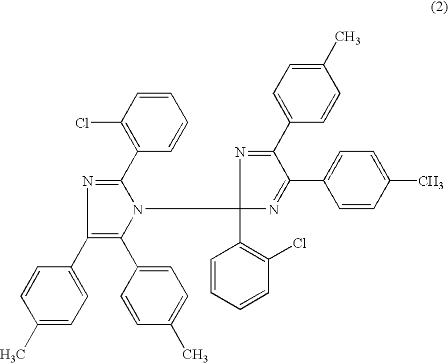

[3] A method of using the hexaarylbiimidazole compound according to [1] or [2], characterized in that it is used as a photoradical generator.

A photopolymerization initiator composition containing the hexaarylbiimidazole compound according to [1].

[5] The photopolymerization initiator composition according to [4], characterized in that it contains one or more compounds selected from the group consisting of benzophenone-based compounds, thioxanthone-based compounds, and ketocoumarin-based compounds.

[6] The photopolymerization initiator composition according to [4], characterized in that it contains as hydrogen donors for the hexaarylbiimidazole compound a thiol compound and/or a dicarbonyl compound as defined by the following formula (3): 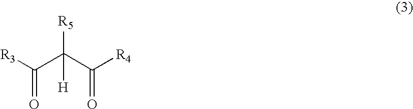
wherein R₃ and R₄ each independently represent optionally substituted alkyl, optionally substituted alkoxy, optionally substituted amino, optionally substituted aralkyl, optionally substituted aryl, optionally substituted aryloxy or an organic group with a polymerizable unsaturated group or polymer compound residue, or R₃ and R₄ may bond together to form a ring. R₅ represents hydrogen, optionally substituted alkyl, optionally substituted aralkyl or optionally substituted aryl.

A photopolymerizable composition characterized in that it comprises at least the following components;

(A) A photopolymerization initiator composition according to any one of [4] to [6]; and

(B) A compound with an ethylenic unsaturated group.

[8] A photopolymerizable composition for a color filter resist, characterized in that it comprises at least the following components;

(A) A photopolymerization initiator composition according to any one of [4] to [6]; and

(B) A compound with an ethylenic unsaturated group.

### BRIEF DESCRIPTION OF THE DRAWINGS

FIG. 1 is an ¹H-NMR spectrum for MHABI.

FIG. 2 is a ¹³C-NMR spectrum for MHABI.

FIG. 3 is a (magnified) ¹³C-NMR spectrum for MHABI.

FIG. 4 is a mass spectrum for mHABI.

FIG. 5 is a photograph of the heated stainless steel of Example 1.

FIG. 6 is a photograph of the heated stainless steel of Comparative Example 1.

### DETAILED DESCRIPTION OF THE INVENTIIN

2,2′-Bis(2-chlorophenyl)-4,4′-5,5′-tetraphenyl-1,2′-biimidazole (formula (4), abbreviated as HABI), as a hexaarylbiimidazole compound conventionally used as a component of photopolymerization initiator compositions for photosensitive compositions, undergoes thermal decomposition during post-baking to the compound represented by formula (5) below. This compound is highly sublimating and its crystals readily adhere to exhaust ducts.

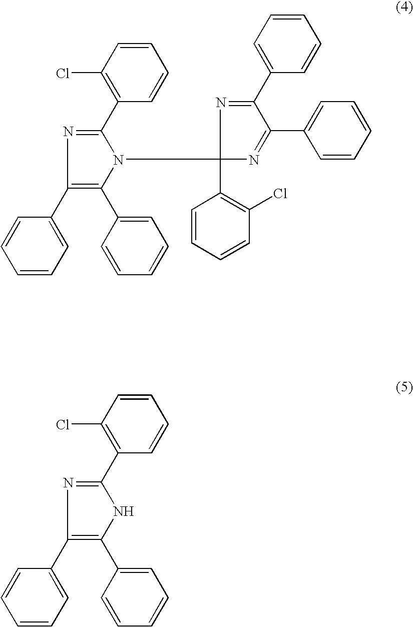

The hexaarylbiimidazole compounds represented by formula (1) of the present invention were first discovered in accomplishing the present invention. The decomposition products of these compounds represented by formula (1) are characterized by low sublimation, unlike HABI, and thus low crystallization onto exhaust ducts during post-baking. It was first discovered according to the invention that these novel hexaarylbiimidazole compounds may be used in photosensitive compositions as photoradical generators to avoid adhesion of crystals onto exhaust ducts during post-baking and thus prevent troubles caused by such crystals.

Embodiments of the invention will now be explained in detail,

1. Hexaarylbiimidazole compounds

The hexaarylbiimidazole compounds of the invention are represented by the following formula (1): 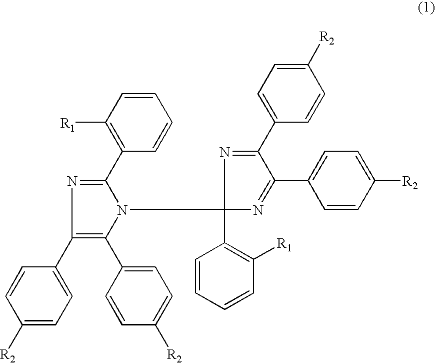
wherein each R₁ represents a halogen, and each R₂ represents an optionally substituted C₁₋₄ alkyl group.

In formula (1), the halogen for R₁ is preferably chlorine. Each R₂ represents an optionally substituted C₁₋₄ alkyl group, and is preferably methyl, ethyl or isopropyl, with methyl being more preferred. As substituents for R₂ there may be mentioned methoxy, ethoxy, propoxy, isopropoxy, n-butoxy, sec-butoxy, tert-butoxy and the like.

As a particularly preferred compound among the hexaarylbiimidazole compounds represented by formula (1) there may be mentioned 2,2′-bis(2-chlorophenyl)-4,4′-5,5′-tetrakis(4-methylphenyl)-1,2′-biimidazole (MHABI) represented by the following formula (2):

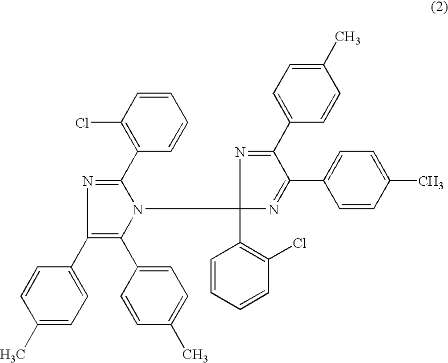

This hexaarylbiimidazole compound of the invention may be suitably used as a photoradical generator in a photosensitive composition (photopolymerizable composition) for a high-sensitivity color filter or the like.

2. Photopolymerization initiator composition

2-(1) Hexaarylbiimidazole compound

A photopolymerization initiator composition according to the invention is characterized by comprising any hexaarylbiimidazole compound represented by formula (1) above. The mixing proportion of the hexaarylbiimidazole compound in the photopolymerization initiator composition is not particularly restricted, but is preferably 20-60 wt % and more preferably 30-50 wt %.

If the proportion of the hexaarylbiimidazole compound is too low, the amount of radical generation is reduced, thereby impairing the photosensitivity or sometimes resulting in insufficient curing of the photopolymerizable composition. If the amount is too high, the relative amount of sensitizing agent or hydrogen donor is reduced and this may also result in an undesirable reduction in photosensitivity.

The photopolymerization initiator composition of the invention may also include other components commonly used in photopolymerization initiator compositions (for example, hydrogen donors, sensitizing agents, additional photopolymerization initiators, etc.) without any particular restrictions so long as it contains the hexaarylbiimidazole compound specified above as the essential component. Such components may be incorporated so that the overall function as a photopolymerization initiator is exhibited, but the following compounds are preferably added.

2-(2) One or more compounds selected from the group consisting of benzophenone-based compounds, thioxanthone-based compounds and ketocoumarin-based compounds

For increased sensitivity, the photopolymerization initiator composition of the invention preferably employs one or more compounds selected from the group consisting of benzophenone-based compounds, thioxanthone-based compounds and ketocoumarin-based compounds as sensitizing agents.

As examples of benzophenone-based compounds there may be mentioned benzophenone, 2,4,6-trimethylbenzophenone, 4-phenylbenzophenone, 4-benzoyl-4′-methyldiphenylsulfide, 4,4′-bis(dimethylamino)benzophenone and 4,4′-bis(diethylamino)benzophenone.

As examples of thioxanthone-based compounds there may be mentioned thioxanthone, 2-methylthioxanthone, 2,4-dimethylthioxanthone, 2,4-diethylthioxanthone, isopropylthioxanthone, 2,4-diisopropylthioxanthone and 2-chlorothioxanthone.

As examples of ketocoumarin-based compounds there may be mentioned 3-acetylcoumarin, 3-acetyl-7-diethylaminocoumarin, 3-benzoylcoumarin, 3-benzoyl-7-diethylaminocoumarin, 3-benzoyl-7-methoxycoumarin, 3,3′-carbonylbiscoumarin, 3,3′-carbonylbis(7-methoxycoumarin) and 3,3′-carbonylbis(5,7-dimethoxycoumarin).

The mixing proportion of the sensitizing agent in the photopolymerization initiator composition is not particularly restricted but is preferably 5-40 wt % and more preferably 10-30 wt % of the total photopolymerization initiator composition. The sensitivity may be reduced if the mixing proportion is too low, while if the proportion is too high, sufficient light may not reach the lower parts of the resist, which may result in inadequate curing of those sections.

2-(3) Thiol compound and/or carbonyl compound

The photopolymerization initiator composition of the invention may also employ a thiol compound and/or carbonyl compound as a hydrogen donor for the aforementioned hexaarylbiimidazole compound.

[1] Thiol compound

A thiol compound used for the invention is not particularly restricted so long as it is a compound with a thiol group in the molecule, and any of those conventionally used in photopolymerization initiator compositions may be selected as desired.

As examples of such thiol compounds there may be mentioned 2-mercaptobenzothiazole, 2-mercaptobenzoimidazole, 2-mercaptobenzooxazole, 5-chloro-2-mercaptobenzothiazole, 2-mercapto-5-methoxybenzothiazole, 5-methyl-1,3,4-thiadiazole-2-thiol, 5-mercapto-1-methyltetrazole, 3-mercapto-4-methyl-4H-1,2,4-triazole, 2-mercapto-1-methylimidazole, 2-mercaptothiazoline, octanethiol, hexanedithiol, decanedithiol, 1,4-dimethylmercaptobenzene, 1,4-butanediol bis(3-mercaptopropionate), 1,4-butanediol bis(mercaptoacetate), ethyleneglycol bis(3-mercaptopropionate), ethyleneglycol bis(mercaptoacetate), trimethylolpropane tris(3-mercaptopropionate), trimethylolpropane tris(mercaptoacetate), pentaerythritol tetrakis(3-mercaptopropionate) and pentaerythritol tetrakis(mercaptoacetate).

Particularly preferred thiol compounds for the invention from the standpoint of storage stability of the photopolymerizable composition include thiol compounds having a structure branched at the α- and/or β-carbon of the thiol group, or “branched” thiol compounds having a structure wherein the α- and/or β-carbons of the thiol group are bonded with 3 atoms other than hydrogen, and for example, there may be mentioned thiol compounds wherein at least one of the substituents other than the main chain of the α- and/or β-position with respect to the thiol is an alkyl group. Here, the main chain represents the structure of the longest chain composed of non-hydrogen atoms, including the thiol group.

Particularly preferred among these are thiol compounds wherein the thiol group-containing structural portion is represented by formula (6) below.
—(CH₂)ₘC(R₆)(R₇)(CH₂)ₙSH (6)
(wherein R₆ and R₇ each independently represent hydrogen or alkyl, with the proviso that R₆ and R₇ are not both hydrogen, m represents an integer of 0-2 and n represents an integer of 0 or 1.)

Here, the alkyl group (R₆ or R₇ in formula (6)) is preferably a linear or branched C₁₋₃ alkyl group.

Specifically, there may be mentioned methyl, ethyl, n-propyl, iso-propyl and the like, with methyl or ethyl being more preferred.

From the standpoint of increased photosensitivity, the thiol compound used for the invention is more preferably a polyfunctional thiol compound having two or more mercapto groups, and in order to achieve both photosensitivity and storage stability of the photosensitive composition, a polyfunctional thiol compound having the structure shown in formula (6) of the invention is particularly preferred. Specifically, the following compounds may be mentioned.

Examples of hydrocarbon dithiols include 2,5-hexanedithiol, 2,9-decanedithiol, 1,4-bis(1-mercaptoethyl)benzene and the like.

As compounds containing ester bond structures there may be mentioned phthalic acid bis(1-mercaptoethyl ester), phthalic acid bis(2-mercaptopropyl ester), phthalic acid bis(3-mercaptobutyl ester), phthalic acid bis(3-mercaptoisobutyl ester), ethyleneglycol bis(3-mercaptobutyrate), diethyleneglycol bis(3-mercaptobutyrate), propyleneglycol bis(3-mercaptobutyrate), 1,4-butanediol bis(3-mercaptobutyrate), 1,3-butanediol bis(3-mercaptobutyrate), 1,2-butanediol bis(3-mercaptobutyrate), trimethylolpropane tris(3-mercaptobutyrate), pentaerythritol tetrakis(3-mercaptobutyrate), dipentaerythritol hexakis(3-mercaptobutyrate), ethyleneglycol bis(2-mercaptoisobutyrate), diethyleneglycol bis(2-mercaptoisobutyrate), propyleneglycol bis(2-mercaptoisobutyrate), 1,4-butanediol bis(2-mercaptoisobutyrate), trimethylolpropane tris(2-mercaptoisobutyrate), pentaerythritol tetrakis(2-mercaptoisobutyrate), dipentaerythritol hexakis(2-mercaptoisobutyrate), ethyleneglycol bis(3-mercaptoisobutyrate), diethyleneglycol bis(3-mercaptoisobutyrate), propyleneglycol bis(3-mercaptoisobutyrate), 1,4-butanediol bis(3-mercaptoisobutyrate), trimethylolpropane tris(3-mercaptoisobutyrate), pentaerythritol tetrakis(3-mercaptoisobutyrate) and dipentaerythritol hexakis(3-mercaptoisobutyrate).

These thiol compounds may be used alone or in combinations of two or more.

When using such thiol compounds, there are no particular restrictions on the mixing proportion of the thiol compounds in the photopolymerization initiator composition, but it is preferably 20-70 wt % and more preferably 30-60 wt % with respect to the total of the photopolymerization initiator composition. If the thiol compound proportion is too low, the surface curing property of the resist may be reduced, while if it is too high, chain transfer of the mercapto group may lower the degree of crosslinking of the cured product.

[2]Carbonyl compound

Preferred carbonyl compounds to be used as hydrogen donors for the invention are represented by the following formula (3): 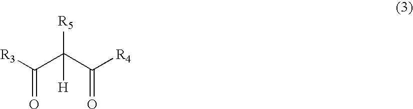
wherein R₃ and R₄ each independently represent optionally substituted alkyl, optionally substituted alkoxy, optionally substituted amino, optionally substituted aralkyl, optionally substituted aryl, optionally substituted aryloxy or an organic group with a polymerizable unsaturated group or polymer compound residue, or R₃ and R₄ may bond together to form a ring. R₅ represents hydrogen, optionally substituted alkyl, optionally substituted aralkyl or optionally substituted aryl.

As alkyl groups for R₃ and R₄ in formula (3) there may be mentioned linear or branched alkyl groups of preferably 1-8 carbons and more preferably 1-6 carbons.

Specific examples include methyl, ethyl, n-propyl, i-propyl, n-butyl, i-butyl, t-butyl, n-pentyl, n-hexyl, n-octyl and 2-ethylhexyl. These may be further substituted with alkoxy, halogens or the like.

As alkoxy groups for R₃ and R₄ in formula (3) there may be mentioned linear or branched alkoxy groups of preferably 1-8 carbons and more preferably 1-6 carbons, and specific examples include methoxy, ethoxy, propoxy, n-butoxy, i-butoxy, t-butoxy, n-pentyloxy, n-hexyloxy, n-octyloxy and 2-ethylhexyloxy. These may be further substituted with alkoxy, halogens or the like.

Amino groups for R₃ and R₄ in formula (3) may having their the hydrogen atoms substituted with hydrocarbon groups such as alkyl, aralkyl or aryl. As alkyl groups to substitute the amino group hydrogens there may be preferably mentioned those with 1-4 carbon atoms such as methyl, ethyl, n-propyl, i-propyl, n-butyl, i-butyl or t-butyl. There may also be mentioned alicyclic hydrocarbon groups such as cyclohexyl and cyclopentyl.

As aralkyl groups to substitute the amino group hydrogens there may be mentioned benzyl, phenethyl and the like. As aryl groups to substitute the amino group hydrogens there may be mentioned phenyl, tolyl, xylyl, cumenyl, mesityl, anisyl and naphthyl. Heterocyclic amino groups having nitrogen atoms in the ring are also suitable, and as such amino groups there may be mentioned morpholino, piperidino and pyrrolidino.

As aralkyl groups for R₃ and R₄ in formula (3) there may be mentioned benzyl and phenethyl. These may be substituted with alkyl, alkoxy, aryl, halogens or the like.

As aryl groups for R₃ and R₄ in formula (3) there may be mentioned phenyl, tolyl, xylyl, cumenyl, mesityl, anisyl, naphthyl and the like. As aryloxy groups there may be mentioned phenoxy and naphthoxy. These may be substituted with alkyl, alkoxy, aryl, halogens or the like.

As organic groups with polymerizable unsaturated groups for R₃ and R₄ in formula (3) there may be mentioned organic groups such as vinyl, vinylidene, acryloyl, methacryloyl, and the like.

An organic group with a polymer compound residue for R₃ and R₄ in formula (3) is one having a polymer compound group comprising several repeating units bonded by polymerization or polycondensation. For example, there may be mentioned groups wherein the organic, groups with polymerizable unsaturated groups are polymerized at the polymerizable unsaturated groups to form a high molecular compound. Stated differently, these may be high molecular substances formed by copolymerization of compounds at R₃ and R₄ in formula (3).

Specifically, there may be mentioned copolymers of 2-acetoacetoxyethyl methacrylate, 2-acetoacetoxyethyl acrylate, 2-acetoacetoxyethyl crotonate or the like, as monomers having carbonyl groups at the 1,3-position, with unsaturated group-containing monomers such as methacrylic acid or methyl methacrylate. There are no particular restrictions on the weight-average molecular weight of the polymer compound residue, but it is preferably 1000 to 1 million.

R₃ and R₄ in formula (3) may also bond together to form a cyclic structure, in which case a compound with 5- to 7-membered ring structure is preferred.

R₅ in formula (3) represents hydrogen, optionally substituted alkyl, optionally substituted aralkyl or optionally substituted aryl.

As alkyl groups there may be mentioned linear or branched alkyl groups of preferably 1-8 carbons and more preferably 1-4 carbons, and specific examples include methyl, ethyl, n-propyl, i-propyl, n-butyl, i-butyl, t-butyl, n-pentyl, n-hexyl, n-octyl and 2-ethylhexyl. Aralkyl groups include benzyl and phenethyl. These may be further substituted with alkyl, aryl, alkoxy, halogens or the like. As aryl groups there may be mentioned phenyl, tolyl, xylyl, cumenyl, mesityl, anisyl, naphthyl and the like. These may also be substituted with alkyl, aryl, alkoxy, halogens or the like.

As compounds of formula (3) there may be mentioned dimethyl malonate, diethyl malonate, di-n-propyl malonate, diisopropyl malonate, di-n-butyl malonate, diisobutyl malonate, di-n-hexyl malonate, di-n-octyl malonate, acetoacetic acid methyl ester, acetoacetic acid ethyl ester, acetoacetic acid n-propyl ester, acetoacetic acid isopropyl ester, acetoacetic acid n-butyl ester, acetoacetic acid isobutyl ester, acetoacetic acid n-hexyl ester, acetoacetic acid n-octyl ester, acetoacetic acid benzyl ester, acetoacetic acid 2-methoxyethyl ester, acetoacetoxyethyl methacrylate, N-methylacetoacetamide, N-ethylacetoacetamide, N,N-dimethylacetoacetamide, N,N-diethylacetoacetamide, N-acetoacetyl-N-morpholine, acetoacetoanilide, N-acetoacetyl-2-chloroaniline, N-acetoacetyl-2,5-dichloroaniline, N-acetoacetyl-p-toluidine, N-acetoacetyl-o-toluidine, 1,3-cyclohexanedione and dimedone.

When a compound of formula (3) is used, the mixing proportion of the carbonyl compound in the photopolymerization is not particularly restricted but is preferably 20-70 wt % and more preferably 30-60 wt %. If the carbonyl compound proportion is too low, the surface curing property of the resist may be reduced, while if it is too high, the degree of crosslinking of the cured product may be reduced.

2-(4) Other components

The photopolymerization initiator composition of the invention may also contain an organoboron salt compound in addition to the components mentioned above.

An organoboron salt compound used for the invention may be any one commonly used in ordinary photopolymerization initiator compositions, but preferably there may be mentioned those having the structure represented by the following formula (7):

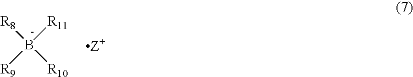

In formula (7), R₈, R₉, R₁₀, and R₁₁ each independently represent optionally substituted alkyl, aryl, aralkyl, alkenyl alkynyl, silyl or a heterocycle, and Z⁺ represents any desired cation. The following may be mentioned as examples of groups represented by R₈, R₉, R₁₀ and R₁₁.

As alkyl groups there are preferred, specifically, substituted or unsubstituted linear or branched alkyl groups of 1-12 carbon atoms, and as examples there may be mentioned methyl, ethyl, n-propyl, isopropyl, n-butyl, isobutyl, sec-butyl, tert-butyl, n-pentyl, n-hexyl, n-octyl, dodecyl, cyanomethyl, 4-chlorobutyl, 2-ethylaminoethyl and 2-methoxyethyl.

As examples of aryl groups there may be mentioned substituted or unsubstituted phenyl, tolyl, xylyl, mesityl, 4-methoxyphenyl, 2-methoxyphenyl, 4-n-butylphenyl, 4-tert-butylphenyl, naphthyl, 4-methylnaphthyl, anthryl, phenanthryl, 4-nitrophenyl, 4-trifluoromethylphenyl, 4-fluorophenyl, 4-chlorophenyl and 4-dimethylaminophenyl.

As examples of aralkyl groups there may be mentioned substituted or unsubstituted benzyl, phenethyl, 1-naphthylmethyl, 2-naphthylmethyl and 4-methoxybenzyl.

As examples of alkenyl groups there may be mentioned substituted or unsubstituted vinyl, propenyl, butenyl and octenyl.

As examples of heterocyclic groups there may be mentioned substituted or unsubstituted pyridyl, 4-methylpyridyl, quinolyl and indolyl.

As examples of alicyclic groups there may be mentioned substituted or unsubstituted cyclohexyl, 4-methylcyclohexyl, cyclopentyl, cycloheptyl and the like.

R₉ in formula (7) is preferably methyl, ethyl, n-propyl or n-butyl, and R₉-R₁₁ are each preferably phenyl, tolyl, 4-t-butyl, naphthyl or 4-methylnaphthyl.

Z⁺ is preferably an ammonium cation, sulfonium cation, oxosulfonium cation, pyridinium cation, phosphonium cation, oxonium cation or iodonium cation.

As specific examples of ammonium cations there may be mentioned tetramethylammonium cation, tetraethylammonium cation, tetra-n-propylammonium cation, tetra-n-butylammonium cation, n-butyltriphenylammonium cation, tetraphenylammonium cation and benzyltriphenylammonium cation.

As specific examples of sulfonium cations there may be mentioned triphenylsulfonium cation, tri(4-tolyl)sulfonium cation and 4-tert-butylphenyldiphenylsulfonium cation.

As specific examples of oxosulfonium cations there may be mentioned triphenyloxosulfonium cation, tri(4-tolyl)oxosulfonium cation and 4-tert-butylphenyldiphenyloxosulfonium cation.

As specific examples of pyridinium cations there may be mentioned N-methylpyridinium cation and N-n-butylpyridinium cation.

As specific examples of phosphonium cations there may be mentioned tetramethylphosphonium cation, tetra-n-butylphosphonium cation, tetra n-octylphosphonium cation, tetraphenylphosphonium cation and benzyltriphenylphosphonium cation.

As specific examples of oxonium cations there may be mentioned triphenyloxonium cation, tri(4-tolyl)oxonium cation and 4-tert-butylphenyldiphenyloxonium cation.

As specific examples of iodonium cations there may be mentioned diphenyliodonium cation, di(4-methylphenyl)iodonium cation and di(4-tert-butylphenyl)iodonium cation.

As examples of organoboron salt compounds represented by formula (7) there may be mentioned tetramethylammonium n-butyltriphenylborate, tetraethylammonium isobutyltriphenylborate, tetra-n-butylammonium n-butyltri(4-tert-butylphenyl)borate, tetra-n-butylammonium n-butyltrinaphthylborate, tetra-n-butylammonium methyltri(4-methylnaphthyl)borate, triphenylsulfonium n-butyltriphenylborate, triphenyloxosulfonium n-butyltriphenylborate, triphenyloxonium n-butyltriphenylborate, N-methylpyridinium n-butyltriphenylborate, tetraphenylphosphonium n-butyltriphenylborate and diphenyliodonium n-butyltriphenylborate.

Since the organoboron salt compound represented by formula (7) usually absorbs virtually no light of a wavelength of 300 nm or greater, it is virtually insensitive to ordinary ultraviolet lamp light sources when used alone, but by combination with a sensitizing agent it is possible to achieve very high sensitivity.

When an organoboron salt compound is used with the hexaarylbiimidazole compound of the invention, the sum of the hexaarylbiimidazole compound and the organoboron salt compound in the photopolymerizable composition is preferably a total of 20-60 wt % and more preferably 30-50 wt %. If the proportion of the hexaarylbiimidazole compound and organoboron salt compound is too low, radical generation may be insufficient resulting in the disadvantage of poor photosensitivity or inadequate curing, while if it is too high, the relative amount of the sensitizing agent or hydrogen donor is decreased, resulting in the disadvantage of reduced photosensitivity.

3. Photopolymerizable composition

The photopolymerizable composition of the invention is characterized by comprising (A) the aforementioned photopolymerization initiator composition of the invention and (B) a compound with an ethylenic unsaturated group. It may also include a binder resin or coloring pigment.

3-(1) Compound with ethylenic unsaturated group

The compound with an ethylenic unsaturated group in the photopolymerizable composition of the invention is a compound which polymerizes and crosslinks by radicals generated from the photoradical polymerization initiator upon light irradiation, and it may be any from among either monomers or polymers.

3-(1)-[1] Monomers

(Meth)acrylic acid esters are preferably used as the monomers. Specifically, there may be mentioned alkyl (meth)acrylates such as methyl (meth)acrylate, ethyl (meth)acrylate, propyl (meth)acrylate, butyl (meth)acrylate, isobutyl (meth)acrylate, sec-butyl (meth)acrylate, tert-butyl (meth)acrylate, hexyl (meth)acrylate, octyl (meth)acrylate, isooctyl (meth)acrylate, 2-ethylhexyl (meth)acrylate, decyl (meth)acrylate, lauryl (meth)acrylate and stearyl (meth)acrylate;

alicyclic (meth)acrylates such as cyclohexyl (meth)acrylate, isobornyl (meth)acrylate, dicyclopentenyl (meth)acrylate and dicyclopentenyloxyethyl (meth)acrylate;

aromatic (meth)acrylates such as benzyl (meth)acrylate, phenyl (meth)acrylate, phenylcarbitol (meth)acrylate, nonylphenyl (meth)acrylate, nonylphenylcarbitol (meth)acrylate and nonylphenoxy (meth)acrylate;

hydroxyl group-containing (meth)acrylates such as 2-hydroxyethyl (meth)acrylate, hydroxypropyl (meth)acrylate, hydroxybutyl (meth)acrylate, butanediol mono(meth)acrylate, glycerol (meth)acrylate, polyethyleneglycol (meth)acrylate and glycerol di(meth)acrylate;

amino group-containing (meth)acrylates such as 2-dimethylaminoethyl (meth)acrylate, 2-diethylaminoethyl (meth)acrylate and 2-tert-butylaninoethyl (meth)acrylate;

phosphorus-containing methacrylates such as methacryloxyethyl phosphate, bismethacryloxyethyl phosphate and methacryloxyethylphenyl acid phosphate (phenyl P);

diacrylates such as ethyleneglycol di(meth)acrylate, diethyleneglycol di(meth)acrylate, triethyleneglycol di(meth)acrylate, tetraethylene di(meth)acrylate, polyethylene glycol di(meth)acrylate, propyleneglycol di(meth)acrylate, dipropyleneglycol di(meth)acrylate, tripropyleneglycol di(meth)acrylate, 1,4-butanediol di(meth)acrylate, 1,3-butanediol di(meth)acrylate, neopentylglycol di(meth)acrylate, 1,6-hexanediol di(meth)acrylate and bisglycidyl (meth)acrylate;

polyacrylates such as trimethylolpropane tri(meth)acrylate, pentaerythritol tri(meth)acrylate and dipentaerythritol hexa(meth)acrylate; modified polyol polyacrylates such as ethylene oxide 4-molar addition diacrylates of bisphenol S, ethylene oxide 4-molar addition diacrylates of bisphenol A, aliphatic acid mcdified pentaerythritol diacrylates, propylene oxide 3-molar addition triacrylates of trimethylolpropane and propylene oxide 6-molar addition triacrylates of trimethylolpropane.

isocyanuric acid backbone-containing polyacrylates such as bis(acryloyloxyethyl)monohydroxyethyl isocyanurate, tris(acryloyloxyethyl) isocyanurate and ε-caprolactone-added tris(acryloyloxyethyl) isocyanurate; polyester acrylates such as α,ω-diacryloyl(bisethyleneglycol) phthalate and α,ω-tetraacryloyl(bistrimethylolpropane) tetrahydrophthalate; and

glycidyl (meth)acrylate; allyl (meth)acrylate; ω-hydroxyhexanoyloxyethyl (meth)acrylate; polycaprolactone (meth)acrylate; (meth)acryloyloxyethyl phthalate; (meth)acryloyloxyethyl succinate; 2-hydroxy-3-phenoxypropyl acrylate; phenoxyethyl acrylate and the like.

N-vinyl compounds such as n-vinylpyrrolidone, n-vinylformamide and n-vinylacetamide may also be suitably used as monomers.

As preferred compounds among these for increased photosensitivity there may be mentioned polyacrylates such as trimethylolpropane tri(meth)acrylate, pentaerythritol tri(meth)acrylate and dipentaerythritol hexa (meth)acrylate.

3-(1)-[12] Polymers

As polymers there may be mentioned epoxy (meth)acrylate, urethane (meth)acrylate and ethylenic unsaturated group-containing acrylic copolymers, but since developing is carried out in an alkali aqueous solution for such uses as resists and color filters, carboxyl group-containing polymers are preferred. Here, the term “polymers” also includes low molecular “prepolymers” and “oligomers”.

<Carboxyl group-containing epoxy (methlacrylate (EA)>

There are no particular restrictions on a carboxyl group-containing epoxy (meth)acrylate used for the invention, and suitable epoxy (meth)acrylates include any of those obtained by reacting an acid anhydride with the reaction product of an epoxy compound and an unsaturated group-containing monocarboxylic acid.

There are no particular restrictions on epoxy compounds, and there may be mentioned epoxy compounds such as bisphenol A epoxy compounds, bisphenol F epoxy compounds, bisphenol S epoxy compounds, phenol-novolac epoxy compounds, cresol-novolac epoxy compounds and aliphatic epoxy compounds. These may be used alone or in combinations of two or more.

As examples of unsaturated group-containing monocarboxylic acids there may be mentioned (meth)acrylic acid, 2-(meth)acryloyloxyethylsuccinic acid, 2-(meth)acryloyloxyethylphthalic acid, (meth)acryloyloxyethylhexahydrophthalic acid, (meth)acrylic acid dimer, β-furfurylacrylic acid, β-styrylacrylic acid, cinnamic acid, crotonic acid, α-cyanocinnamic acid and the like. There may also be mentioned half esters which are reaction products of hydroxyl group-containing acrylates and saturated or unsaturated dibasic acid anhydrides, and half esters which are reaction products of unsaturated group-containing monoglycidyl ethers and saturated or unsaturated dibasic acid anhydrides. These unsaturated group-containing monocarboxylic acids may be used alone or in combinations of two or more.

As acid anhydrides there may be mentioned dibasic acid anhydrides such as maleic anhydride, succinic anhydride, itaconic anhydride, phthalic anhydride, tetrahydrophthalic anhydride, hexahydrophthalic anhydride, methylhexahydrophthalic anhydride, endomethylenetetrahydrophthalic anhydride, methylendomethylenetetrahydrophthalic anhydride, chlorendic anhydride and methyltetrahydrophthalic anhydride, aromatic polyvalent carboxylic anhydrides such as trimellitic anhydride, pyromellitic anhydride and benzophenonetetracarboxylic dianhydride, or polyvalent carboxylic anhydride derivatives such as 5-(2,5-dioxotetrahydrofuryl)-3-methyl-3-cyclohexene-1,2-dicarboxylic anhydride and endobicyclo-[2,2,1]-hept-5-ene-2,3-dicarboxylic anhydride. These may also be used alone or in combinations of two or more.

The molecular weight of a carboxyl group-containing epoxy (meth)acrylate obtained in this manner is not particularly restricted, but the weight-average molecular weight based on polystyrene according to GPC is preferably 1000-40,000 and more preferably 2000-5000.

The acid value of the aforementioned epoxy (meth)acrylate compound (the solid acid value measured according to JIS K0070, same hereunder) is preferably at least 10 mgKOH/g, more preferably in the range of 45-160 mgKOH/g and even more preferably in the range of 50-140 mgKOH/g, for a satisfactory balance between the alkali developing property (alkali solubility) and the alkali resistance of the hardened film. The alkali solubility is reduced if the acid value is lower than 10 mgKOH/g, while an excessively high acid value can result in lower alkali-resistant or other properties of the hardened film, depending on the combination of components in the curable resin composition for a resist.

<Carboxyl group-containig urethane (neth)acrylate (UA)>

A carboxyl group-containing urethane (meth)acrylate compound used for the invention can serve as a more flexible binder resin than an acrylic copolymer or epoxy (meth)acrylate, and therefore is suitable for purposes requiring flexibility and bending resistance.

A carboxyl group-containing urethane (meth)acrylate compound is a compound containing a hydroxyl group-containing (meth)acrylate-derived unit, a polyol-derived unit and a polyisocyanate-derived unit as structural units. More specifically, it comprises repeating units wherein both ends are composed of hydroxyl group-containing (meth)acrylate-derived units while the regions between both ends are composed of urethane bond-linked polyol-derived units and polyisocyanate-derived units, and the carboxyl groups are present in the repeating units.

In other words, a carboxyl group-containing urethane (meth)acrylate compound is represented by —(OR_{b}O— OCNHR_{c}NHCO)ₙ— (where OR_{b}O is the dehydrogenated residue of a polyol and R_{c} is the deisocyanated residue of a polyisocyanate).

A carboxyl group-containing urethane (meth)acrylate compound may be produced by reacting at least a hydroxyl group-containing (meth)acrylate (a) with a polyol (b) and a polyisocyanate (c), but a carboxyl group-containing compound must be used for either or both the polyol and the polyisocyanate, with a carboxyl group-containing polyol being preferred. By thus using a carboxyl group-containing compound as the polyol and/or polyisocyanate, it is possible to produce a urethane (meth)acrylate compound having a carboxyl group in R_{b} or R_{c}. In the above formula, n is preferably about 1-200 and more preferably 2-30. A value for n in this range will result in more excellent flexibility of the hardened film.

When two or more of either or both of the polyol and the polyisocyanate are used, the repeating units will be of a plurality of types, and the regularity of the plurality of units may be appropriately selected from among total random, block, localized, etc. depending on the purpose.

As hydroxyl group-containing (meth)acrylates (a) there may be mentioned 2-hydroxyethyl (meth)acrylate, hydroxypropyl (meth)acrylate, hydroxybutyl (meth)acrylate, caprolactone or alkylene oxide addition products of the aforementioned (meth)acrylates, glycerin mono(meth)acrylate, glycerin di(meth)acrylate, glycidyl methacrylate-acrylic acid addition product, trimethylolpropane mono(meth)acrylate, trimethylol di(meth)acrylate, pentaerythritol tri(meth)acrylate, dipentaerythritol penta(meth)acrylate, trimethylolpropane-alkylene oxide addition product-di(meth)acrylate and the like.

These hydroxyl group-containing (meth)acrylates (a) may be used alone or in combinations of two or more different types. Preferred among these are 2-hydroxyethyl (meth)acrylate, hydroxypropyl (meth)acrylate and hydroxybutyl (meth)acrylate, with 2-hydroxyethyl (meth)acrylate being more preferred. Using 2-hydroxyethyl (meth)acrylate will facilitate synthesis of the carboxyl group-containing urethane (meth)acrylate compound (UA).

A polyol (b) used for the invention may be a polymer polyol and/or dihydroxy compound. As polymer polyols there may be mentioned polyether diols such as polyethylene glycol, polypropylene glycol and polytetramethylene glycol, polyester diols obtained from esters of polyhydric alcohols and polybasic acids, polycarbonate diols containing units derived from hexamethylene carbonate, pentamethylene carbonate or the like as structural units, and polylactone diols such as polycaprolactone diol and polybutyrolactone diols.

When using a carboxyl group-containing polymer polyol, for example, a trivalent or greater polybasic acid such as trimellitic acid (or anhydride) may be added during the polymer polyol synthesis to obtain a compound synthesized so that the carboxyl group remains.

The polymer polyol may be one or a combination of two or more of those mentioned above. Polymer polyols with a number-average molecular weight of 200-2000 will result in more excellent flexibility of the hardened film.

A dihydroxy compound which is used may be a linear or branched compound having two alcoholic hydroxyl groups, but carboxyl group-containing dihydroxy aliphatic carboxylic acids are particularly preferred. As such dihydroxy compounds there may be mentioned dimethylolpropionic acid and dimethyolbutanoic acid. By using a carboxylic group-containing dihydroxy aliphatic carboxylic acid it is possible to easily include a carboxyl group in the urethane (meth)acrylate compound. one or a combination of two or more dihydroxy compounds may be used, optionally together with a polymer polyol.

When a carboxyl group-containing polymer polyol is used in combination therewith, or when a carboxyl group-containing compound is used as the polyisocyanate as described below, a dihydroxy compound with no carboxyl groups may be used, such as ethylene glycol, diethylene glycol, propylene glycol, 1,4-butanediol, 1,3-butanediol, 1,5-pentanediol, neopentyl glycol, 3-methyl-1,5-pentanediol, 1,6-hexanediol or 1,4-cyclohexane dimethanol.

As specific polyisocyanates to be used for the invention there may be mentioned diisocyanates such as 2,4-toluene diisocyanate, 2,6-toluene diisocyanate, isophorone diisocyanate, hexamethylene diisocyanate, diphenylmethylene diisocyanate, (o, m or p)-xylene diisocyanate, methylenebis(cyclohexyl isocyanate), trimethylhexamethylene diisocyanate, cyclohexane-1,3-dimethylene diisocyanate, cyclohexane-1,4-dimethylene diisocyanate and 1,5-naphthalene diisocyanate. These polyisocyanates may be used alone or in combinations of two or more. A carboxyl group-containing polyisocyanate may also be used.

The molecular weight of a carboxyl group-containing urethane (meth)acrylate used for the invention is not particularly restricted, but the weight-average molecular weight based on polystyrene according to GPC is preferably 1000-40,000 and more preferably 8000-30,000.

Also, the acid value of the carboxyl group-containing urethane (meth)acrylate compound (UA) is preferably 5-150 mgXOH/g and more preferably 30-120 mgKOH/g.

If the weight-average molecular weight of the carboxyl group-containing urethane (meth)acrylate compound (UA) is less than 1000, the elongation and strength of the hardened film may be impaired, and if it is greater than 40,000, the film may become harder and less flexible. With an acid value of less than 5 mgKOH/g, the alkali solubility (developing property) of the curable resin composition for a resist may be impaired, and if it is greater than 150 mgKOH/g, the alkali resistance of the hardened film may be impaired.

<Carboxyl group- and ethylenic unsaturated group-containing acrylic copolymer (AP-A)>

A carboxyl group- and ethylenic unsaturated group-containing acrylic copolymer may be obtained by copolymerizing a) a carboxyl group-containing ethylenic unsaturated monomer and b) an ethylenic unsaturated monomer other than a), and then reacting some of the carboxyl groups on side chains of the acrylic copolymer (AP-B), obtained by copolymerization of the monomers, with the epoxy groups of a compound having an epoxy group and ethylenic unsaturated group in each molecule, such as glycidyl (meth)acrylate or allylglycidyl ether, or reacting some or all of the hydroxyl groups of the acrylic copolymer with the isocyanate groups of a compound having an isocyanate group and an ethylenic unsaturated group in each molecule, such as 2-methacryloyloxyethyl isocyanate, to introduce ethylenic unsaturated groups in side chains.

The carboxyl group-containing ethylenic unsaturated monomer a) is used for the purpose of conferring an alkali developing property to the acrylic copolymer. Specific examples of carboxyl group-containing ethylenic unsaturated monomers include (meth)acrylic acid, 2-(meth)acryloyloxyethylsuccinic acid, 2-(meth)acryloyloxyethylphthalic acid, (meth)acryloyloxyethylhexahydrophthalic acid, (meth)acrylic acid dimer, maleic acid, crotonic acid, itaconic acid, fumaric acid and the like.

The ethylenic unsaturated monomer b) other than a) mentioned above is used for the purpose of controlling the coating (resist, color filter) strength and pigment dispersability. As specific examples there may be mentioned vinyl compounds such as styrene, α-methylstyrene, (o, m, p-)hydroxystyrene and vinyl acetate, (meth)acrylates such as methyl (meth)acrylate, ethyl (meth)acrylate, n-propyl (meth)acrylate, isopropyl (meth)acrylate, n-butyl (meth)acrylate, tert-butyl (meth)acrylate, n-hexyl (meth)acrylate, cyclohexyl (meth)acrylate, benzyl (meth)acrylate, phenoxyethyl (meth)acrylate, isobornyl (meth)acrylate, tetrahydrofurfuryl (meth)acrylate, (meth)acrylonitrile, glycidyl (meth)acrylate, allylglycidyl ether, 2-hydroxyethyl (meth)acrylate, 2-hydroxypropyl (meth)acrylate, N,N-dimethylaminoethyl (meth)acrylate, trifluoroethyl acrylate, 2,2,3,3-tetrafluoropropyl (meth)acrylate and perfluorooctylethyl (meth)acrylate, and amides such as (meth)acrylamide, N,N-dimethyl (meth)acrylamide, N,N-diethyl (meth)acrylamide, N-methyl (meth)acrylamide, N-ethyl (meth)acrylamide, N-isopropyl (meth)acrylamide, N-vinylpyrrolidone, N-vinylcaprolactam and N-(meth) acryloylmorpholine.

The copolymerization ratio of a) and b) is preferably 5:95 to 40:60 and more preferably 10:90 to 35:65 based on weight. If the copolymerization ratio of a) is less than 5, the alkali developing property is reduced and it becomes difficult to form patterns. If the copolymerization ratio of a) is greater than 40, alkali development will tend to proceed at the photoset sections, making it difficult to maintain a constant line width.

The preferred molecular weight for a carboxyl group- and ethylenic unsaturated group-containing acrylic copolymer is in the range of 1000-500,000 and more preferably 3000-200,000 in terms of the weight-average molecular weight based on polystyrene according to gel permeation chromatography (GPC). At less than 1000, the film strength is notably reduced. At greater than 500,000, the alkali solubility (developing property) is considerably reduced.

The aforementioned ethylenic unsaturated group-containing monomers and polymers may also be used as combinations of two or more different types.

3-(2) Binder resin

The photopolymerizable composition of the invention may also include a binder resin with no ethylenic unsaturated group. As such binder resins there may be mentioned epoxy resins, polyester resins and urethane resins, but for use in a resist, carboxyl group-containing acrylic copolymers are particularly preferred. As such acrylic copolymers there may be mentioned the carboxyl group-containing acrylic copolymers (AP-B), and as preferred AP-B copolymers there may be mentioned those prior to reaction with compounds having ethylenic unsaturated groups on the side chains of AP-A as mentioned above.

3-(3) Coloring pigment

When the photopolymerizable composition of the invention is used for a color filter, it will contain a coloring pigment. The common color tones used for color filters are additive color mixtures of reds, greens and blues, subtractive color mixtures of cyans, magentas and yellows, as well as blacks used for black matrix sections. While both dyes and pigments may be used as coloring agents, pigments are preferably used from the standpoint of heat resistance and light fastness. Combinations of two or more different pigments are often used to obtain appropriate spectra, and for example, appropriate spectra may be obtained for blue by combining cyan pigments and violet pigments, for green by combining green pigments and yellow pigments, and for red by combining red pigments and yellow or orange pigments.

The following may be mentioned as coloring pigments to be used for the invention, indicated by their color index numbers. C. I. Pigment Yellow 12, 13, 14, 17, 20, 24, 55, 83, 86, 93, 109, 110, 117, 125, 137, 139, 147, 15 148, 153, 154, 166, 168, C. I. Pigment Orange 36, 43, 51, 55, 59, 61, C. I. Pigment Red 9, 97, 122, 123, 149, 168, 177, 180, 192, 215, 216, 217, 220, 223, 224, 226, 227, 228, 240, C. I. Pigment Violet 19, 23, 29, 30, 37, 40, 50, C. I. Pigment Blue 15, 15:1, 15:4, 15:6, 22, 60, 64, C. I. Pigment Green 7, 36, C. I. Pigment Brown 23, 25, 26.

As black pigments there may be mentioned carbon blacks, titanium blacks and the like, and as specific examples of carbon blacks there may be mentioned special Black 4, Special Black 100, Special Black 250, Special Black 350 and Special Black 550 by Degussa, Raven 1040, Raven 1060, Raven 1080 and Raven 1255 by Colombia Carbon and MA7, MA8, MA11, MA100, MA220 and MA230 by Mitsubishi Chemical.

3-(4) Other components

A solvent is preferably used in the photopolymerizable composition of the invention to adjust the viscosity for more suitable coating. As examples of solvents there may be mentioned methanol, ethanol, toluene, cyclohexane, isophorone, cellosolve acetate, diethyleneglycol dimethyl ether, ethyleneglycol diethyl ether, xylene, ethylbenzene, methylcellosolve, ethylcellosolve, butylcellosolve, propyleneglycol monomethyl ether, propyleneglycol monomethyl ether acetate, diethyleneglycol monoethylether acetate, isoamyl acetate, ethyl lactate, methyl ethyl ketone, acetone, cyclohexane and the like, any of which may be used alone or in combinations of two or more.

3-(15) Production of photopolymerizable composition

When the photopolymerizable composition of the invention contains a pigment, it may be produced by mixing each of the aforementioned components using dispersing means such as a triple roll mill, double roll mill, sand mill, attritor, ball mill, kneader, paint shaker or the like. A polymerization inhibitor may be added in order to prevent gelling due to polymerization during dispersion, or a monomer or photoinitiator may be added after dispersion of the pigment. An appropriate dispersing aid may also be added for more satisfactory dispersion of the pigment. A dispersing aid has the effect of facilitating dispersion of the pigment and preventing reflocculation after dispersion.

### EXAMPLES

The present invention will now be explained through examples, with the understanding that the examples are in no way limitative on the invention.

### Synthesis

### Synthesis of biimidazole compound synthesis Example 1: Synthesis of 2,2′-bis(2-chlorophenyl)-4,4′-5,5′-tetrakis(4-methylphenyl)-1,2-biimidazole (hereinafter abbreviated as MHABI)

After placing 27.50 g (115 mmol) of 4,4′-dimethylbenzyl (Tokyo Kasei Kogyo Co., Ltd,), 16.25 g (116 mmol) of o-chlorbenzaldehyde (Tokyo Kasei Kogyo Co., Ltd.), 69.45 g (901 mmol) of ammonium acetate (Junsei Chemicals Co., Ltd.) and 450 g of acetic acid (Junsei Chemicals Co., Ltd.) in a 1 L volume flask, the mixture was reacted at 117° C. for 5 hours while stirring. The reaction mixture was allowed to cool and then slowly poured into 2 L of stirred deionized water to precipitate 2-chlorophenyl-4,5-bis(4-methylphenyl)imidazole. After filtering and washing the 2-chlorophenyl-4,5-bis(4-methylphenyl)imidazole, it was dissolved in 500 g of methylene chloride (Junsei Chemicals Co., Ltd.), and the solution was charged into a 2 L volume 4-necked flask and cooled to 5-10° C. A mixture of 117.6 g (357 mmol) of potassium ferricyanide (Junsei Chemicals Co., Ltd.), 44.7 g of sodium hydroxide (Junsei Chemicals Co., Ltd.) and 600 g of deionized water was then added thereto while stirring over a period of one hour, and reaction was conducted for 18 hours at room temperature. The reaction mixture was washed three times with deionized water and then dehydrated with approximately 50 g of anhydrous magnesium sulfate (Junsei Chemicals Co., Ltd.), after which the methylene chloride was distilled off under reduced pressure to produce crystals of MHABI. The MHABI was recrystallized from ethanol (Junsei Chemicals Co., Ltd.) and then filtered and dried to obtain 36.5 g of product as light yellow crystals (88.7% yield).

The chemical formula of the obtained MEABI was C₄₆H₃₆N₄C₂ and the molecular weight was 715.70.

### Structural Analysis

(1) ¹H-NMR

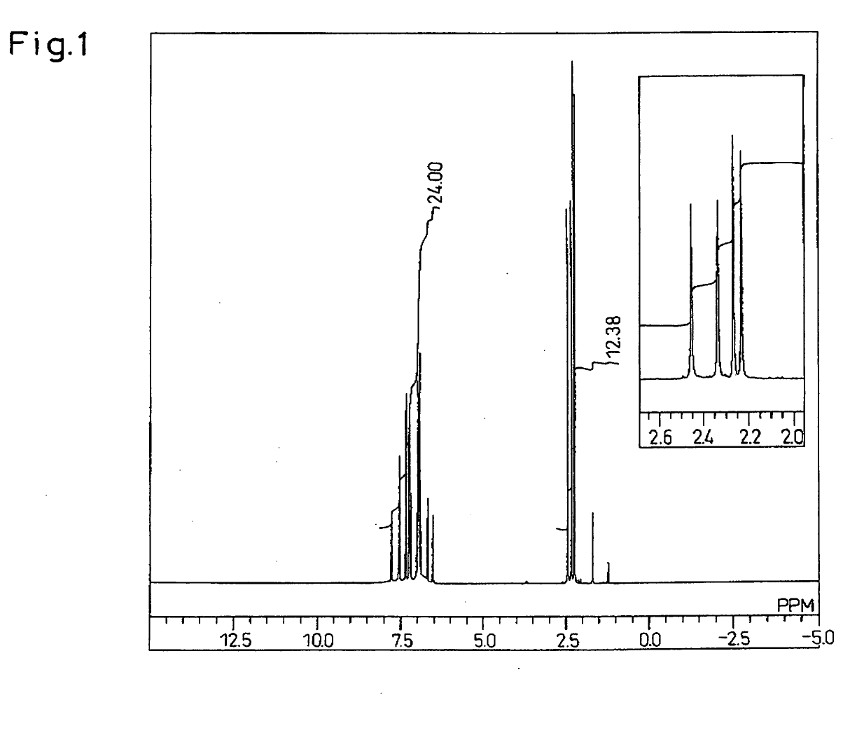

The ¹H-NMR chart for the MHABI is shown in FIG. 1. The ¹H-NMR was measured in heavy chloroform using JNM-AL400 by JEOL.

(2) ¹³C-NMR

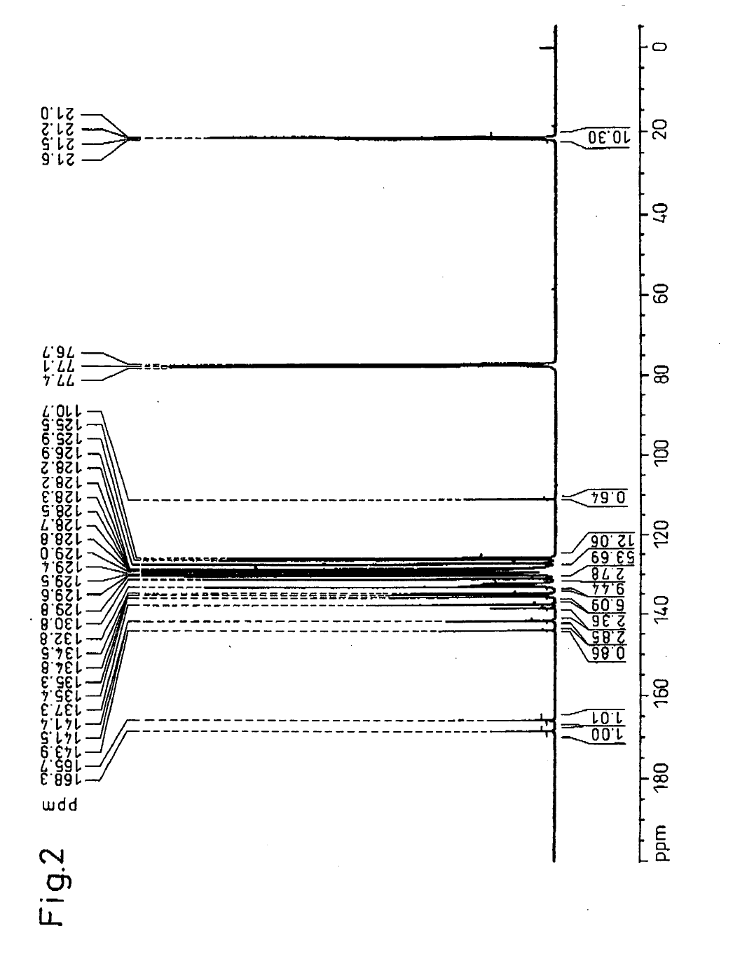

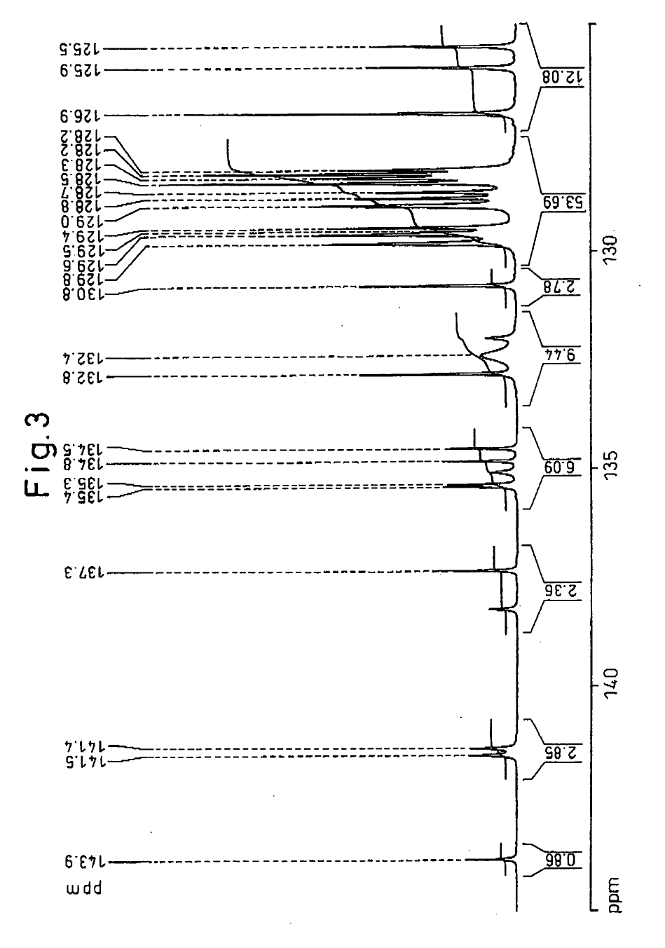

¹³C-NMR charts for MHABI are shown in FIG. 2 and FIG. 3. The ¹³C-NMR was measured in heavy chloroform using AMX400 by Bruker. Characteristic chemical shifts were assigned. 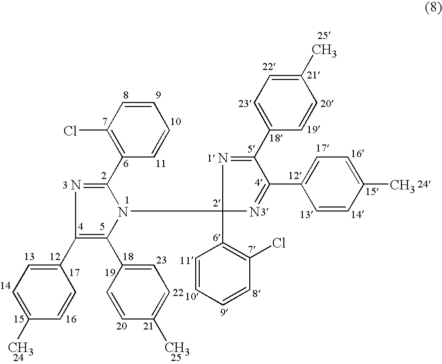
21.0, 21.2, 21.5, 21.6 ppm: carbon atoms of methyl groups at 24, 25, 24′, 25′ 110.7 ppm: 2′ carbon atom
(3) Mass spectrometry

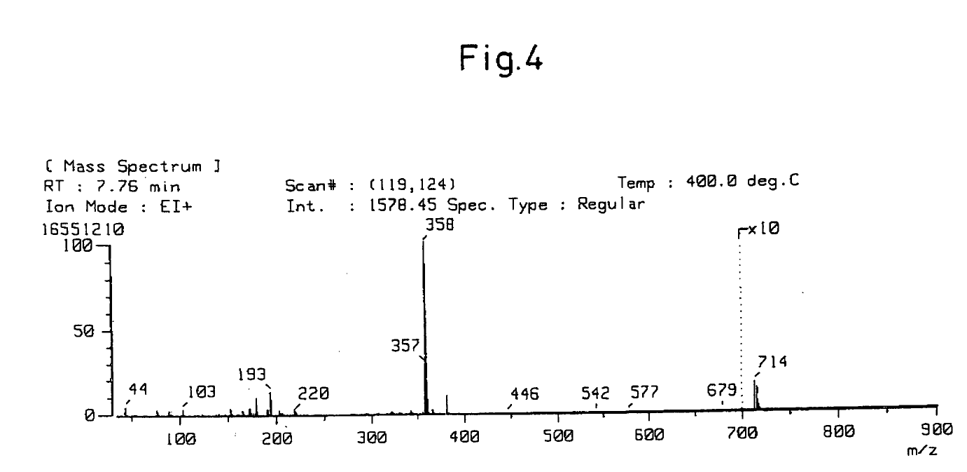

The mass spectrum of the MHABI was measured using JMS-SX102A by JEOL. The chart is shown in FIG. 4. The molecular weight of the MHABI was 715.69, and a molecular ion peak was detected at 714. The values matched the molecular weight of MHABI containing no atomic isotopes.

(4) Melting point

The melting point was measured using a Model 510 melting point apparatus by Buchi. The melting point of the MHABI was 211° C.

### Synthesis of binder resin

Synthesis Example 2: Carboxyl group-containing acrylic copolymer (AP-B), AP-1: 25 wt % solution of carboxyl group-containing acrylic copolymer (solvent: propyleneglycol methyl ether acetate, hereinafter abbreviated as PGMEA, product of Tokyo Kasei Kogyo Co., Ltd.)

After charging 11.25 parts by weight of methacrylic acid (hereinafter abbreviated as MAA, product of Kyoeisha Chemical Co., Ltd.), 15.00 parts by weight of methyl methacrylate (hereinafter abbreviated as MMA, product of Kyoeisha Chemical), 41.25 parts by weight of n-butyl methacrylate (hereinafter abbreviated as BMA), 7.50 parts by weight of 2-hydroxyethyl methacrylate (hereinafter abbreviated as HEMA, product of Kyoeisha Chemical) and 210.0 parts by weight of PGMEA into a 4-necked flask equipped with a dropping funnel, thermometer, condenser tube, stirrer and nitrogen introduction tube, the 4-necked flask was nitrogen-substituted for one hour.

After heating to 90° C., a mixture of 11.25 parts by weight of MAA, 15.00 parts by weight of MMA, 41.25 parts by weight of BMA, 7.50 parts by weight (0.0776 mol) of HEMA, 210.0 parts by weight of PGMEA and 3.20 parts by weight of 2,2′-azobisisobutyronitrile (abbreviated as AIBN, product of Wako Pure Chemical Industries, Ltd.) was added dropwise over a period of one hour. After polymerization for 3 hours and heating to 100° C., a mixture of 1.0 part by weight of AIBN and 30.0 parts by weight of PGMEA was added prior to an additional 1.5 hours of polymerization to obtain a carboxyl group-containing acrylic copolymer (AP-1). The weight-average molecular weight of the AP-1 (measured by GPC, based on polystyrene) was 26,000.

Synthesis of ethylenic unsaturated group-containing compound

Synthesis Example 3: Carboxyl group- and ethylenic unsaturated group-containing acrylic copolymer (AP-A), AP-2: 26 wt % solution of carboxyl group- and ethylenic unsaturated group-containing acrylic copolymer (solvent: PGMEA

After adding 600 parts by weight of the carboxyl group-containing acryl copolymer AP-1, 8.8 g of 2-methacryloyloxyethyl isocyanate (Karenz MOI, product of Showa Denko K.K.) and 0.36 g of dibutyltin dilaurate (product of Tokyo Kasei Kogyo Co., Ltd.) into a 4-necked flask equipped with a thermometer, condenser tube, stirrer and nitrogen introduction tube, reaction was conducted at 60° C. for 3 hours while bubbling in air, and then the reaction mixture was cooled to obtain AP-2.

Synthesis Example 4: Synthesis of carboxyl group-containing epoxy acrylate (EA), EA-1: 60 wt % solution of carboxyl group-containing epoxy acrylate (solvent: diethyleneglycol monoethylether acetate)

After charging 210 parts by weight of cresol-novolac epoxy resin (EPOTOTO YDCN-704, epoxy equivalents: 210, softening point: 90° C., product of Toto chemical Co., Ltd.), 72 parts by weight of acrylic acid (product of Tokyo Kasei Kogyo Co., Ltd.), 0.28 part by weight of hydroquinone (product of Tokyo Kasei Kogyo Co., Ltd.) and 232.6 parts by weight of diethyleneglycol monoethylether acetate (product of Tokyo Kasei Kogyo Co., Ltd.), the mixture was heated to 95° C., and upon confirming uniform dissolution, 1.4 parts by weight of triphenylphosphine (product of Tokyo Kasei Kogyo Co., Ltd.) was charged, the mixture was heated to 100° C., and reaction was conducted for approximately 30 hours to obtain a reaction mixture with an acid value of 0.5 mgKOH/g. Into this there was charged 66.9 parts by weight of tetrahydrophthalic anhydride, the mixture was heated to 90° C., reaction was conducted for approximately 6 hours, loss of absorption by the acid anhydride was confirmed by IR (infrared absorption spectrum), and a carboxyl group-containing epoxy acrylate resin EA-1 was obtained having a solid acid value of 70 mgKOH/g and a solid concentration of 60.0%.

### Evaluation of photopolymerizable composition Reagents

Ethylenic unsaturated group-containing compound (monomer)

Dipentaerythritol hexaacrylate; product of Toa Gosei Co., Ltd.

### Photopolymerization initiators

1) EMK (4,4′-bis(N,N-diethylamino)benzophenone; product of Hodogaya Chemical Co., Ltd.

2) HABI (2,2′-bis(2-chlorophenyl)-4,4′,5,5′-tetraphenyl-1,2′-biimidazole: product of Hodogaya Chemical Co., Ltd. 3) MN3M (tetra-n-butylammonium methyltris(4-methylnaphthyl)borate): synthesized by process described in Japanese Unexamined Patent Publication HEI No. 11-222489

4) TPMP (trimethylolpropanetris(3-mercaptopropionate)): product of Yodo Kagaku Co., Ltd.

5) Dimedone: product of Tokyo Kasei Kogyo Co., Ltd.

### Pigment

1) Carbon black: Special Black 4, product of Degussa

### Other Components

1) PGMEA (propyleneglycol monomethylether acetate): product of Tokyo Kasei Kogyo Co., Ltd.
2) Cyclohexane: product of Wako Pure Chemical Industries, Ltd.
3) FLOWLEN DOPA-33: Dispersing agent, amino group-containing acrylic copolymer, solid concentration: 30 wt %, main solvent: cyclohexanone, product of Kyoeisha Chemical Co., Ltd.
   Preparation of photopolymerizable composition

### Example 1

After mixing 196.0 parts by weight of acryl copolymer AP-1 (49.0 parts by weight solid portion, 147 parts by weight solvent portion), 65.0 parts by weight of Special Black 4, 21.7 parts by weight of FLOWLEN DOPA-33 (dispersing agent: product of Kyoeisha Chemical Co., Ltd.) (6.5 parts by weight solid portion, 15.2 parts by weight solvent portion) and 200.0 parts by weight of 30; cyclohexanone, a paint conditioner (product of Asada Iron Works Co., Ltd.) was used for 3 hours of dispersion.

In this dispersion there were mixed and dissolved 35.0 parts by weight of the ethylenic unsaturated group-containing compound EA-1 (21.0 parts by weight solid portion, 14.0 parts by weight solvent portion), 38.5 parts by weight of dipentaerythritol hexaacrylate, 5.0 parts by weight of 4,4′-bis(N,N-diethylamino)benzophenone (hereinafter abbreviated as “EMK”), 15.0 parts by weight of MHABI, 15.0 parts by weight of TPMP and 600.0 parts by weight of cyclohexanone. The composition was then filtered with a 0.8 μm pore filter (Kiriyama filter paper for GFP) to obtain a photopolymerizable composition of the invention. The physical properties of the resulting photopolymerizable composition were evaluated by the following methods. The results are shown in Table 1.

### Example 2, Comparative Examples 1.2

Examples 2 and Comparative Examples 1 and 2 were carried out in the same manner as Example 1, except that the amounts listed in Table 1 were used. The physical properties of the resulting photopolymerizable composition were evaluated as in Example 1. The results are shown in Table 1.

Evaluation methods

(1) Residual film sensitivity

The obtained photopolymerizable composition was spin coated onto a glass substrate (100×100 mm) to a dry film thickness of about 1.5 μm, dried at room temperature for 30 minutes, and then vacuum dried at room temperature for 10 minutes. The film thickness of the dried coating was precisely measured with a film thickness measuring instrument (SURFCOM130A, product of Tokyo Seimitsu Co., Ltd.), after which an exposure apparatus with a ultrahigh pressure mercury lamp (“Multilight ML-251A/B” by Ushio, Inc.) was used to expose the photopolymerizable composition to light while varying the light exposure through a quartz photomask, for photosetting. The light exposure was measured using an ultraviolet integrating photometer (“UIT-150” with “UVD-S365” receiver, by Ushio Inc.). A 5, 10, 30, 50, 70, 100 μm line/space pattern was formed in the quartz photomask used. The gap between the photomask and the coating was set to 100 μm. The exposed coating was alkali developed for a prescribed period in a 0.1% aqueous sodium carbonate solution (25° C.). The developing time was set to 1.5 times the time period: tD required to completely dissolve the coating by alkali development of the coating before exposure. The time period tD was determined as the time required for complete dissolution of the coating through repeated experimentation wherein the degree of dissolution of the coating with different alkali developing times was observed. After alkali development, the glass substrate was washed and dried by air spraying, and the film thickness of the residual coating (resist) was measured to calculate the film residue rate, according to the following equation:

Film residue rate (%)=100×(film thickness after alkali developing)/(film thickness before alkali developing)

The same photosetting procedure was conducted while varying the light exposure, and then the relationship between light exposure and film residue rate was plotted on a graph and the light exposure (mJ/cm²) at which the film residue rate reached saturation was recorded as the film residue sensitivity. A smaller value indicates higher sensitivity.

(2) Sublimates during post-baking

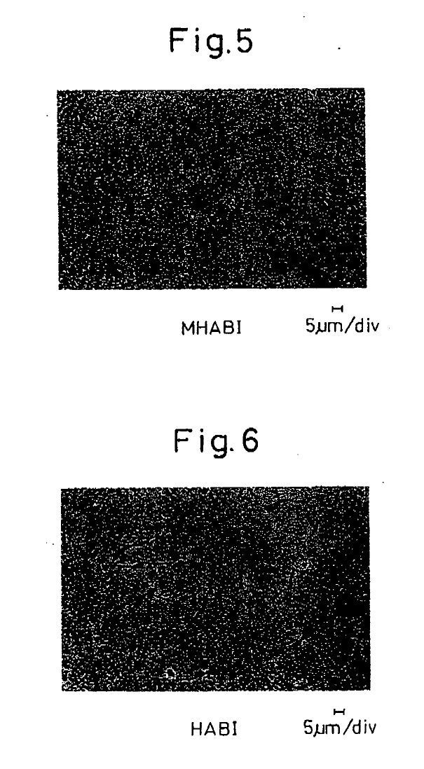

The obtained photopolymerizable composition was spin coated onto a glass substrate (100×100×1 mm) to a dry film thickness of about 1.5 μm, dried at room temperature for 30 minutes, and then vacuum dried at room temperature for 10 minutes. The aforementioned exposure apparatus was then used to irradiate 100 mJ/cm² of light for photosetting. The obtained substrate was placed in a dish which was then situated in a hot plate to allow heating. A stainless steel substrate (200×200×1 mm) was placed on the dish, and a water-containing dish was placed thereover to allow cooling of the stainless steel substrate. After heating the glass substrate with the hot plate at 230° C. for 30 minutes, the cured film-derived sublimates adhering onto the stainless steel substrate were observed with an optical microscope (VH-Z250, product of Keyence Corporation) and the presence or absence of crystallization was visually judged. The results are shown in FIG. 5 (Example 1) and FIG. 6 (Comparative Example 1). Although crystals were produced (the bird footprint-like marks in FIG. 6) when HABI was used, no crystals were apparent when MHABI was used.

TABLE 1

| | | Example | Example | Comp. | Comp. |
|---|---|---|---|---|---|
| Photopolymerizable composition | (values in parts by weight) | 1 | 2 | Ex. 1 | Ex. 2 |
| Binder resin | AP-1*¹ (25.0 wt % solid portion) | 196.0 | 140.0 | 196.0 | 140.0 |
| Ethylenic unsaturated group- | | | | | |
| containing compound | | | | | |
| Polymers | AP-2*² (26.0 wt % solid portion) | | 130.0 | | 130.0 |
| | EA-1*³ (60.0 wt % solid portion) | 35.0 | | 35.0 | |
| Monomer | Dipentaerythritol hexaacrylate | 38.5 | 38.5 | 38.5 | 38.5 |
| Dispersing agent | FLOWLEN DOPA-33*⁴ (30.0 wt % | 21.7 | 21.7 | 21.7 | 21.7 |
| | solid portion) | | | | |
| Coloring material | Carbon black*⁵ | 65.0 | 65.0 | 65.0 | 65.0 |
| Photopolymerization initiator | | | | | |
| Sensitizer | EMK*⁶ | 5.0 | 5.0 | 5.0 | 5.0 |
| Photoradical generator | MHABI*⁷ | 15.0 | 10.0 | | |
| | HABI*⁸ | | | 15.0 | 10.0 |
| | MN3M*⁹ | | 5.0 | | 5.0 |
| Hydrogen donor | TPMP*¹⁰ | 15.0 | | 15.0 | |
| | Dimedone | | 15.0 | | 15.0 |
| Organic solvent | Cyclohexanone | 800.0 | 760.0 | 800.0 | 760.0 |
| Evaluation results | | | | | |
| Film residue sensitivity (mJ/cm²) | | 20 | 20 | 40 | 40 |
| Presence/absence of crystals | | absent | absent | present | present |

*¹Methacrylic acid/methyl methacrylate/n-butyl methacrylate/2-hydroxyethyl methacrylate = 15/20/55/10 (weight ratio) copolymer, Mw = 26,000, solid concentration: 25 wt %, solvent: PGMEA.
*²Acrylic copolymer comprising 2-isocyanate ethyl methacrylate added to AP-1, solid concentration: 26 wt %, solvent: PGMEA.
*³Carboxyl group-containing cresol-novolak epoxy acrylate, solid concentration: 60 wt %, acid value: 70 mgKOH/g.
*⁴FLOWLEN DOPA-33*⁴: dispersion agent, amino group-containing acrylic copolymer, solid concentration: 30 wt %, main solvent: cyclohexanone.
*⁵Special Black 4
*⁶4,4′-Bis(N,N-diethylamino)benzophenone
*⁷2,2′-Bis(2-chlorophenyl)-4,4′,5,5′-tetrakis(4-methylphenyl)-1,2′-biimidazole
*⁸2,2′-Bis(2-chlorophenyl)-4,4′,5,5′-tetraphenyl-1,2′-biimidazole
*⁹Tetra-n-butylammonium methyltris(4-methylnaphthyl)borate
*¹⁰Trimethylolpropane tris(3-mercaptopropionate)

The novel hexaarylbiimidazole compounds of the present invention have low sublimating thermal decomposition products, and when used as components of photopolymerization initiator compositions in photosensitive compositions, they do not generate sublimates even during the post-baking steps for manufacturing of resists of color filters and the like.

It is thus possible to prevent troubles that often occur when using photosensitive compositions comprising conventional photopolymerization initiators, such as adhesion of generated sublimates to exhaust ducts and the like and falling of such adhesion onto resists,

Photopolymerization initiator compositions of the invention employing the aforementioned hexaarylbiimidazole compounds are especially effective for photopolymerizable compositions to be used as various resists such as solder resists, etching resists, photoresists and the like, and particularly for photopolymerizable compositions which can be suitably used as color filter resists for production of color filters to be employed in color liquid crystal display elements, cameras and the like.

1. An hexaarylbiimidazole compound as defined by the following formula (1): 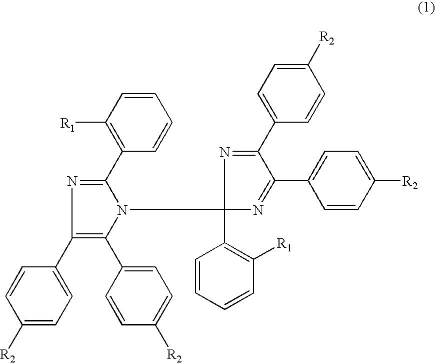
wherein each R₁ represents a halogen atom, and each R₂ represents an optionally substituted C₁₋₄ alkyl group:

2. A hexaarylbiimidazole compound as defined by the following formula (2):

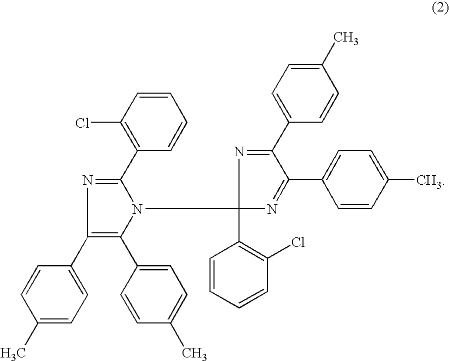

3. A method of using the hexaarylbiimidazole compound according to claim 1 or 2, characterized in that it is used as a photoradical generator.

4. A photopolymerization initiator composition containing the hexaarylbiimidazole compound according to claim 1.

5. The photopolymerization initiator composition according to claim 4, characterized in that it contains one or more compounds selected from the group consisting of benzophenone-based compounds, thioxanthone-based compounds and ketocoumarin-based compounds.

6. The photopolymerization initiator composition according to claim 4, characterized in that it contains as hydrogen donors for the hexaarylbiimidazole compound a thiol compound and/or a dicarbonyl compound as defined by the following formula (3): 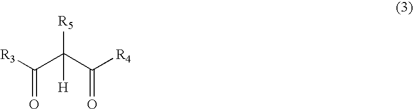
wherein R₃ and R₄ each independently represent optionally substituted alkyl, optionally substituted alkoxy, optionally substituted amino, optionally substituted aralkyl, optionally substituted aryl, optionally substituted aryloxy or an organic group with a polymerizable unsaturated group or polymer compound residue, or R₃ and R₄ may bond together to form a ring. R₅ represents hydrogen, optionally substituted alkyl, optionally substituted aralkyl or optionally substituted aryl.

7. A photopolymerizable composition characterized in that it comprises at least the following components;
(A) A photopolymerization initiator composition according to any one of claims 4 to 6; and
(B) A compound with an ethylenic unsaturated group.

8. A photopolymeri.zable composition for a color filter resist, characterized in that it comprises at least the following components:
(A) A photopolymerization initiator composition according to any one of claims 4 to 6; and
(B) A compound with an ethylenic unsaturated group.
